(19) United States
(12) Patent Application Publication
(10) Pub. No.: US 2022/0413856 A1
(43) Pub. Date: Dec. 29, 2022

(54) INSTRUCTION EXECUTION METHOD, APPARATUS AND DEVICE, AND STORAGE MEDIUM

(71) Applicant: INSPUR (BEIJING) ELECTRONIC INFORMATION INDUSTRY CO., LTD., Beijing (CN)

(72) Inventors: Baoyu Fan, Beijing (CN); Hongbin Yang, Beijing (CN); Gang Dong, Beijing (CN)

(73) Assignee: INSPUR (BEIJING) ELECTRONIC INFORMATION INDUSTRY CO., LTD., Beijing (CN)

(21) Appl. No.: 17/780,809

(22) PCT Filed: Apr. 27, 2020
(86) PCT No.: PCT/CN2020/087109

§ 371 Date: May 27, 2022

(30) Foreign Application Priority Data
Dec. 12, 2019 (CN) 201911276584.4

(51) Int. Cl. G06F 9/30

(52) U.S. Cl. CPC G06F 9/30072

(57) ABSTRACT

An instruction execution method, apparatus and device, and a storage medium are provided. According to the method, normal execution of the instructions without an execution dependency relationship in the batch processing process is ensured, and meanwhile, ordered execution of the instructions with the execution dependency relationship is ensured, and then the correctness of instruction execution results is ensured. In addition, the present application further provides an instruction execution apparatus and device and a storage medium, and the beneficial effects are the same as described above.

The present application claims the priority of Chinese patent application No. 201911276584.4, filed with the Chinese Patent Office on Dec. 12, 2019 and entitled “Instruction Execution Method, Apparatus and Device, and Storage Medium”, the contents of which are incorporated herein by reference in its entirety.

### TECHNICAL FIELD

The present application relates to the field of deep learning, in particular to an instruction execution method, apparatus and device, and a storage medium.

### BACKGROUND

Convolutional Neural Networks (CNNs) are a type of feedforward neural networks (FNNs) with convolutional computation and deep structure, which is one of the representative algorithms of deep learning.

In the current batch processing process based on convolutional neural networks, a user software is required to provide the computing device with batch data to be processed and instructions for batch processing of the batch data, while the batch processing of each piece of data in the batch data often further contains the sequential execution of multiple operations, and the execution of each operation requires the computing device to execute the corresponding instructions, and the data in the batch data may be subject to further multi-branch operations on the execution results of a certain operation process and aggregation of multiple execution results during the batch processing process. Therefore, a dependency often exists between the instructions for batch processing of batch data, and ordered execution of the instructions is difficult to be ensured currently, and further the correctness of instruction execution results is difficult to be ensured.

Therefore, it may be seen that, it is a problem to be solved by those skilled in the art to provide an instruction execution method to relatively ensure ordered execution of the instructions in the batch processing process, and further ensure correctness of instruction execution results.

### SUMMARY

The present application aims at providing an instruction execution method, apparatus and device and a storage medium, to relatively ensure ordered execution of the instructions in the batch processing process, and further ensure correctness of instruction execution results.

To solve the above technical problem, the present application provides an instruction execution method, including:

obtaining an instruction stream, and obtaining an execution relationship between instructions, the instruction stream including an instruction indicating that contents of a first flag bit and a second flag bit are empty;

obtaining, according to the execution relationship between instructions, special instructions with an execution dependency relationship and common instructions without the execution dependency relationship in the instruction stream;

establishing a data access relationship of the second flag bit of a first special instruction and the first flag bit of a second special instruction in the special instructions to a same storage address, the first special instruction being executed adjacent to the second special instruction and executed before the second special instruction;

setting state information satisfying an executable standard to the first flag bit that executes a special instruction with the highest priority;

executing the common instructions;

determining whether there are unexecuted special instructions in the instruction stream or not;

obtaining a target special instruction with the state information corresponding to the first flag bit satisfying the executable standard from the unexecuted special instructions if there are unexecuted special instructions in the instruction stream, and executing the target special instruction;

after the target special instruction is executed, setting state information satisfying the executable standard for a second flag bit of the target special instruction, and performing the step of determining whether there are unexecuted special instructions in the instruction stream or not; and

stopping executing the instruction stream if there are no unexecuted special instructions in the instruction stream. Preferably, establishing a data access relationship of the second flag bit of a first special instruction and the first flag bit of a second special instruction in the special instructions to a same storage address includes:

obtaining a control register allocation table and obtaining a target control register in an unallocated state according to the control register allocation table; and

establishing the data access relationship of the second flag bit of the first special instruction and the first flag bit of the second special instruction in the special instructions to the same register storage address of the target control register.

Preferably, the method further includes:

obtaining a common register allocation table and obtaining a target common register in an unallocated state according to the common register allocation table; and

storing instruction parameters in the instruction other than the first flag bit and the second flag bit by using the target common register.

Preferably, after executing the common instruction, the method further includes:

releasing the common register corresponding to the common instruction, and setting the allocation state of the common register corresponding to the common instruction in the common register allocation table to an unallocated state;

the method further includes:

releasing the common register corresponding to the target special instruction, and setting the allocation state of the common register corresponding to the target special instruction in the common register allocation table to an unallocated state; and

releasing the control register corresponding to the target special instruction, and setting the allocation state of the control register corresponding to the target special instruction in the control register allocation table to an unallocated state.

Preferably, the common register allocation table and the control register allocation table are both dictionary-type data structures.

Preferably, setting state information satisfying an executable standard to the first flag bit that executes a special instruction with the highest priority includes:

setting a standard value for the control register corresponding to the first flag bit that executes the special instruction with the highest priority;

the obtaining a target special instruction with the state information corresponding to the first flag bit satisfying the executable standard from the unexecuted special instructions includes:

reading the unexecuted special instruction and obtaining the state value stored in the corresponding control register according to the first flag bit of the unexecuted special instruction;

determining whether the state value is equal to the standard value;

if the state value is equal to the standard value, setting the unexecuted special instruction to the target special instruction;

after the target special instruction is executed, the setting state information satisfying the executable standard for a second flag bit of the target special instruction includes:

after the target special instruction is executed, setting the standard value for the control register corresponding to the second flag bit of the target special instruction.

Preferably, the standard values take values including 0 or 1.

In addition, the present application further provides an instruction execution apparatus, including:

an obtaining module, configured to obtain an instruction stream, and obtain an execution relationship between instructions, the instruction stream including an instruction indicating that contents of a first flag bit and a second flag bit are empty;

an instruction classification module, configured to obtain, according to the execution relationship between instructions, special instructions with an execution dependency relationship and common instructions without the execution dependency relationship in the instruction stream;

a relationship establishment module, configured to establish a data access relationship of the second flag bit of a first special instruction and the first flag bit of a second special instruction in the special instructions to a same storage address, the first special instruction being executed adjacent to the second special instruction and executed before the second special instruction;

a first flag bit setting module, configured to set state information satisfying an executable standard to the first flag bit that executes a special instruction with the highest priority;

a common instruction execution module, configured to execute the common instructions;

a determining module, configured to determine whether there are unexecuted special instructions in the instruction stream or not, if so, call in turn a special instruction execution module and a second flag bit setting module, otherwise, call a stopping module;

a special instruction execution module, configured to obtain a target special instruction with the state information corresponding to the first flag bit satisfying the executable standard from the unexecuted special instructions, and execute the target special instruction;

a second flag bit setting module, configured to, after the target special instruction is executed, set state information satisfying the executable standard for a second flag bit of the target special instruction, and call the determining module; and a stopping module, configured to stop executing the instruction stream.

In addition, the present application further provides an instruction execution device, including:

a memory, configured to store computer programs; and

a processor, configured to implement, when executing the computer programs, the steps of the above instruction execution method. In addition, the present application further provides a computer-readable storage medium, the computer-readable storage medium stores a computer program, and the computer program, when being executed by the processor, implements the steps of the above instruction execution method.

As to the instruction execution method provided in the present application, first an instruction stream is obtained, the instruction of the instruction stream contains a first flag bit and a second flag bit and the contents are both empty, and further special instructions with an execution dependency relationship and common instructions without the execution dependency relationship in the instruction stream are obtained according to the execution relationship between instructions, a data access relationship is established of a second flag bit of a first special instruction executed first and a first flag bit of a second special instruction executed later in the adjacent special instructions to the same storage address, state information satisfying an executable standard is set to the first flag bit that executes a special instruction with the highest priority, and then a common instruction is executed, and when there are unexecuted special instructions in the instruction stream, the target special instruction with the state information corresponding to the first flag bit satisfying the executable standard is executed, and the state information satisfying an executable standard is set to the second flat bit of the target special instruction, until all the special instructions are executed. Since the instruction of the instruction stream contains the first flag bit and the second flag bit, when the instruction is executed, special instructions with an execution dependency relationship and common instructions without the execution dependency relationship are executed in a differentiated manner, between any two adjacently executed instructions with an execution dependency relationship, the second flag bit executing the instruction first and the first flag bit executing the instruction later share the same storage address, therefore, after the execution of the instruction which is executed first is finished, state information satisfying an executable standard is set to the second flag bit, and execution of the instruction executed later adjacent to the instruction executed first is further triggered, therefore, normal execution of the instructions without an execution dependency relationship in the batch processing process is ensured, and meanwhile, ordered execution of the instructions with the execution dependency relationship is ensured, and then the correctness of instruction execution results is ensured. In addition, the present application further provides an instruction execution apparatus, device and a storage medium, and the beneficial effects are the same as the above.

### BRIEF DESCRIPTION OF THE DRAWINGS

FIG. 1 is a flow chart of an instruction execution method disclosed in the embodiments of the present application;

FIG. 2 is a flow chart of a specific instruction execution method disclosed in the embodiments of the present application;

FIG. 3 is a flow chart of a specific instruction execution method disclosed in the embodiments of the present application;

FIG. 4 is a schematic diagram of convolutional network computation disclosed in a scenario embodiment of the present application;

FIG. 5 is a structural schematic diagram of an instruction execution apparatus disclosed in the embodiments of the present application.

### DETAILED DESCRIPTION

A clear and complete description of the technical solutions in the embodiments of the present application will be given in combination with the accompanying drawings in the embodiments of the present application. Obviously, the described embodiments are merely a part but not all of the embodiments of the present application. Based on the embodiments in the present application, all the other embodiments obtained by those skilled in the art without any creative effort shall all fall within the protection scope of the present application.

In the current batch processing process based on convolutional neural networks, a user software is required to provide the computing device with batch data to be processed and instructions for batch processing of the batch data, while the batch processing of each piece of data in the batch data often further contains the sequential execution of multiple operations, and the execution of each operation requires the computing device to execute the corresponding instructions, and the data in the batch data may be subject to further multi-branch operations on the execution results of a certain operation process and aggregation of multiple execution results during the batch processing process. Therefore, a dependency often exists between the instructions for batch processing of batch data, and ordered execution of the instructions is difficult to be ensured currently, and further the correctness of instruction execution results is difficult to be ensured.

To this end, the core of the present application is to provide an instruction execution method, to relatively ensure ordered execution of the instructions in the batch processing process, and further ensure correctness of instruction execution results.

In order that those skilled in the art may better understand the solutions of the present application, the present application will be further described in detail below in combination with accompanying drawings and specific embodiments.

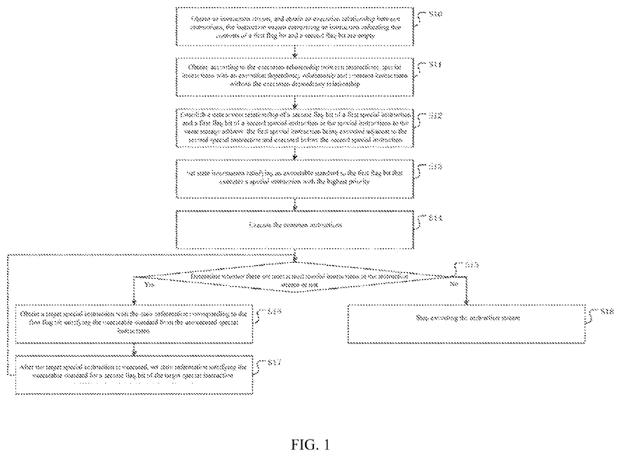

Please refer to FIG. 1, embodiments of the present application disclose an instruction execution method, including:

Step S10: obtaining an instruction stream, and obtaining an execution relationship between instructions, the instruction stream including an instruction indicating that contents of a first flag bit and a second flag bit are empty.

The obtained instruction stream in this step is a sequence consisting of instructions, the instruction stream may be sent from a host to a master controller, and the instruction stream includes a plurality of instructions for performing a particular type of operation, wherein the instructions for the particular type of operation include, but are not limited to, instructions related to performing a convolutional neural network computation, such as convolutional instructions, activation instructions, etc.

The execution relationship between instructions obtained in this step refers to the execution dependency relationship between the instructions in the instruction stream, for example, instruction 1, instruction 2 and instruction 3 are included in the instruction stream, and the execution relationship between the instructions in the instruction stream is executed in an order of instruction 1, instruction 2 and instruction 3, and in the execution relationship, instruction 2 needs to be executed continuously after instruction 1 is executed and instruction 3 needs to be executed continuously after instruction 2 is executed.

In addition, in the obtained instruction stream, the instruction contains a first flag bit and a second flag bit with contents being both empty, and further the dependency relationship between the execution of each instruction is marked by the first flag bit and second flag bit in the subsequent steps.

Step S11: obtaining, according to the execution relationship between instructions, special instructions with an execution dependency relationship and common instructions without the execution dependency relationship in the instruction stream.

The focus of this step lies in that after obtaining the execution relationship between instructions, the special instruction with an execution dependency relationship and common instruction without the execution dependency relationship are obtained in the instruction stream according to the execution relationship between instructions, so as to classify the instructions in the instruction stream into two types, i.e., instructions with execution dependency relationship and instructions without execution dependency relationship, and for the instructions without execution dependency relationship, the execution order between instructions does not need to be considered during execution. While for special instructions with execution dependency relationship, the execution order between special instructions is correlated according to the first flag bit and the second flag bit of the special instructions.

Step S12: establishing a data access relationship of the second flag bit of a first special instruction and the first flag bit of a second special instruction in the special instructions to a same storage address, the first special instruction being executed adjacent to the second special instruction and executed before the second special instruction.

In this step, the focus lies in obtaining the first special instruction and the second special instruction which are executed adjacently in the special instructions, the first special instruction and the second special instruction are generally two instructions that need to be executed adjacent to each other in the special instruction, wherein the first special instruction is executed before the second special instruction, and after obtaining the first special instruction and the second special instruction, a data access relationship is established of the second flag bit of the first special instruction and the first flag bit of the second special instruction to the same storage address, that is, the second flag bit of the first special instruction and the first flag bit of the second special instruction have a linkage relationship.

Step S13: setting state information satisfying an executable standard to the first flag bit that executes a special instruction with the highest priority.

In this step, the special instruction with the highest priority is executed, i.e., the special instruction that is executed first among all the special instructions, and after setting the state information satisfying an executable standard for the first flag bit of the special instruction with the highest execution priority, the currently executable special instruction may be obtained based on the state information of the first flag bit in each special instruction when the special instruction is executed.

Step S14: executing the common instructions.

It should be noted that since there are no dependency relationships between common instructions, the step to execute a common instruction may be executed before any step after the common instruction is obtained.

Step S15: determining whether there are unexecuted special instructions in the instruction stream or not, if so, performing step S16 to step S17, otherwise, performing step S18.

Step S16: obtaining a target special instruction with the state information corresponding to the first flag bit satisfying the executable standard from the unexecuted special instructions, and executing the target special instruction.

Step S17: after the target special instruction is executed, setting state information satisfying the executable standard for a second flag bit of the target special instruction, and performing step S15.

Step S18: stopping executing the instruction stream.

It should be noted that the execution process of special instructions is that when there are unexecuted special instructions, the target special instruction with the state information corresponding to the first flag bit satisfying the executable standard is executed, and after the execution of the target special instruction is completed, the state information satisfying an executable standard is set to the second flat bit of the target special instruction, and further the special instruction adjacent to the target special instruction and executed after the target special instruction satisfies the execution conditions and is executed as the next round of the target special instruction, until all the special instructions are executed, and finally the effect of ordered execution of special instructions according to the execution dependency relationship is achieved.

As to the instruction execution method provided in the present application, first an instruction stream is obtained, the instruction of the instruction stream contains a first flag bit and a second flag bit and the contents are both empty, and further special instructions with an execution dependency relationship and common instructions without the execution dependency relationship in the instruction stream are obtained according to the execution relationship between instructions, a data access relationship is established of a second flag bit of a first special instruction executed first and a first flag bit of a second special instruction executed later in the adjacent special instructions to the same storage address, state information satisfying an executable standard is set to the first flag bit that executes a special instruction with the highest priority, and then a common instruction is executed, and when there are unexecuted special instructions in the instruction stream, the target special instruction with the state information corresponding to the first flag bit satisfying the executable standard is executed, and the state information satisfying an executable standard is set to the second flat bit of the target special instruction, until all the special instructions are executed. Since the instruction of the instruction stream contains the first flag bit and the second flag bit, when the instruction is executed, special instructions with an execution dependency relationship and common instructions without the execution dependency relationship are executed in a differentiated manner, between any two adjacently executed instructions with an execution dependency relationship, the second flag bit executing the instruction first and the first flag bit executing the instruction later share the same storage address, therefore, after the execution of the instruction which is executed first is finished, state information satisfying an executable standard is set to the second flag bit, and execution of the instruction executed later adjacent to the instruction executed first is further triggered, therefore, normal execution of the instructions without an execution dependency relationship in the batch processing process is ensured, and meanwhile, ordered execution of the instructions with the execution dependency relationship is ensured, and then the correctness of instruction execution results is ensured.

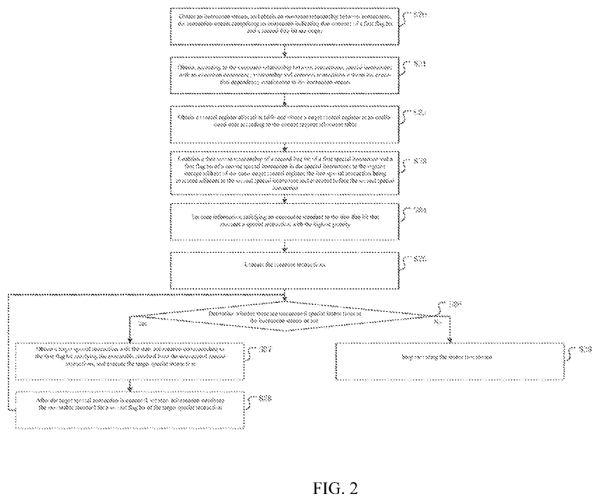

As shown in FIG. 2, embodiments of the present application disclose an instruction execution method, including:

Step S20: obtaining an instruction stream, and obtaining an execution relationship between instructions, the instruction stream including an instruction indicating that contents of a first flag bit and a second flag bit are empty.

Step S21: obtaining, according to the execution relationship between instructions, special instructions with an execution dependency relationship and common instructions without the execution dependency relationship in the instruction stream.

Step S22: obtaining a control register allocation table and obtaining a target control register in an unallocated state according to the control register allocation table.

Step S23: establishing a data access relationship of the second flag bit of a first special instruction and the first flag bit of a second special instruction in the special instructions to the register storage address of a same target control register, the first special instruction being executed adjacent to the second special instruction and executed before the second special instruction.

Step S24: setting state information satisfying an executable standard to the first flag bit that executes a special instruction with the highest priority.

Step S25: executing the common instructions.

Step S26: determining whether there are unexecuted special instructions in the instruction stream or not, if so, performing step S27 to step S28, otherwise, performing step S29.

Step S27: obtaining a target special instruction with the state information corresponding to the first flag bit satisfying the executable standard from the unexecuted special instructions, and executing the target special instruction.

Step S28: after the target special instruction is executed, setting state information satisfying the executable standard for a second flag bit of the target special instruction, and performing step S26.

Step S29: stopping executing the instruction stream.

It should be noted that the control register in the present embodiment is a limitation on the function of the general-purpose register, and the focus lies in providing state information to the first flag bit and the second flag bit of the special instruction through the control register, and a data access relationship is established of a first flag bit and a second flag bit of the special instructions to a cluster storage address of the control register, that is, the state information obtained in the first flag bit or the second flag bit of the special instruction is essentially stored in the control register. In the implementation, firstly, a control register allocation table is obtained, and a target control register in an unallocated state is obtained according to the control register allocation table, and the target control register is just the register that has not yet established a data access relationship with the special instruction, and further the second flag bit of the first special instruction and the first flag bit of the second special instruction in the special instructions both establish a data access relationship with the register storage address of the same target control register. In the present embodiment, by storing the state information of the flag bits of the special instructions in the control register, the state information may be relatively ensured to reliably reflect the execution dependency relationship between special instructions, and further the correctness of the instruction execution is ensured.

On the basis of the above embodiments, as a preferred embodiment, setting state information satisfying an executable standard to the first flag bit that executes a special instruction with the highest priority includes:

setting a standard value for the control register corresponding to the first flag bit that executes the special instruction with the highest priority;

the obtaining a target special instruction with the state information corresponding to the first flag bit satisfying the executable standard from the unexecuted special instructions includes:

reading the unexecuted special instruction and obtaining the state value stored in the corresponding control register according to the first flag bit of the unexecuted special instruction;

determining whether the state value is equal to the standard value;

if the state value is equal to the standard value, setting the unexecuted special instruction to the target special instruction;

after the target special instruction is executed, the setting state information satisfying the executable standard for a second flag bit of the target special instruction includes:

after the target special instruction is executed, setting the standard value for the control register corresponding to the second flag bit of the target special instruction.

It should be noted that, in the present embodiment, the state information satisfying an executable standard is further limited to a standard value, thereby indicating whether the special instruction may be executed by means of a value, which has a relatively efficient and clear effect and further ensures the correctness of the instruction execution.

Further, as a preferred embodiment, the standard values take values including 0 or 1.

Since 0 and 1 may accurately and concisely characterize the two opposing states in which the instructions are executable or non-executable, the standard values including 1 or 0 may relatively ensure the overall efficiency of determining whether the state value is equal to the standard value, thereby further ensuring the overall efficiency of the instruction execution.

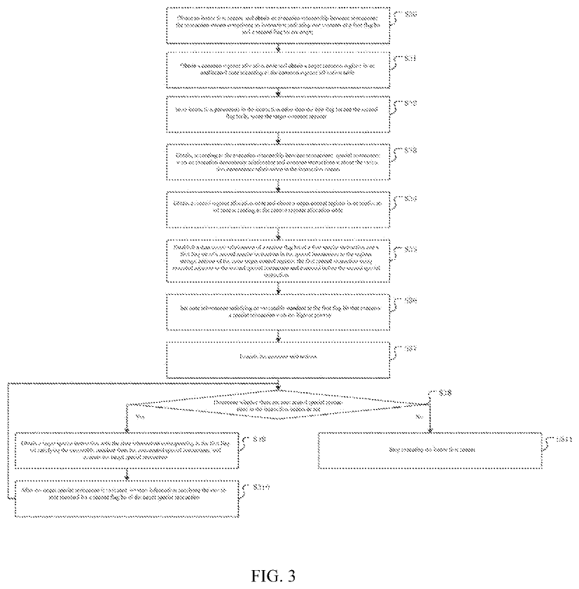

As shown in FIG. 3, embodiments of the present application disclose an instruction execution method, including:

Step S30: obtaining an instruction stream, and obtaining an execution relationship between instructions, the instruction stream including an instruction indicating that contents of a first flag bit and a second flag bit are empty.

Step S31: obtaining a common register allocation table and obtaining a target common register in an unallocated state according to the common register allocation table.

Step S32: storing instruction parameters in the instruction other than the first flag bit and the second flag bit by using the target common register.

Step S33: obtaining, according to the execution relationship between instructions, special instructions with an execution dependency relationship and common instructions without the execution dependency relationship in the instruction stream.

Step S34: obtaining a control register allocation table and obtaining a target control register in an unallocated state according to the control register allocation table.

Step S35: establishing a data access relationship of the second flag bit of a first special instruction and the first flag bit of a second special instruction in the special instructions to the register storage address of a same target control register, the first special instruction being executed adjacent to the second special instruction and executed before the second special instruction.

Step S36: setting state information satisfying an executable standard to the first flag bit that executes a special instruction with the highest priority.

Step S37: executing the common instructions.

Step S38: determining whether there are unexecuted special instructions in the instruction stream or not, if so, performing step S39 to step 5310, otherwise, performing step S311.

Step S39: obtaining a target special instruction with the state information corresponding to the first flag bit satisfying the executable standard from the unexecuted special instructions, and executing the target special instruction.

Step S310: after the target special instruction is executed, setting state information satisfying the executable standard for a second flag bit of the target special instruction, and performing step S38.

Step S311: stopping executing the instruction stream.

It should be noted that, the common register in the present embodiment is a limitation on the function of the general-purpose register, and the focus lies in storing instruction parameters in the instruction of the instruction stream other than the first flag bit and the second flag bit by using the common register, thereby relatively ensuring reliability of instruction parameters in the instruction of the instruction stream, an further ensuring correctness of instruction execution.

On the basis of the above embodiments, as a preferred embodiment, after executing the common instruction, the method further includes:

releasing the common register corresponding to the common instruction, and setting the allocation state of the common register corresponding to the common instruction in the common register allocation table to an unallocated state;

after executing the target special instruction, the method further includes:

releasing the common register corresponding to the target special instruction, and setting the allocation state of the common register corresponding to the target special instruction in the common register allocation table to an unallocated state; and

releasing the control register corresponding to the target special instruction, and setting the allocation state of the control register corresponding to the target special instruction in the control register allocation table to an unallocated state.

It should be noted that, in the present embodiment, after the execution of the common instruction in the instruction stream is completed, the common register corresponding to the common instruction is further released and the allocation state of the common register corresponding to the common instruction in the common register allocation table is set to an unallocated state, and after the execution of the target special instruction is completed, the common register corresponding to the target special instruction is further released, and the allocation state of the common register corresponding to the target special instruction in the common register allocation table is set to an unallocated state, and the control register corresponding to the target special instruction is released, and the allocation state of the control register corresponding to the target special instruction in the control register allocation table is set to an unallocated state. The present embodiment focuses on releasing in time the registers associated with common instructions or special instructions after the execution of the common instructions and special instructions in the instruction stream is completed, thereby relatively avoiding possible shortage of register resources when the registers are allocated again due to the continuous occupation of control registers or common registers, and further ensuring the overall reliability of instruction execution.

In addition, on the basis of the above embodiments, as a preferred embodiment, the common register allocation table and the control register allocation table are both dictionary-type data structures.

It should be noted that, in the present embodiment, the dictionary-type data structure is taken as the respective data structure of the common register allocation table and the control register allocation table because the dictionary-type data structure may accurately record the register number and the register allocation state corresponding to the register number based on the key-value data correspondence, thereby relatively ensuring the correctness of the contents of the common register allocation table and the control register allocation table, and further ensuring the correctness of the instruction execution.

In order to further deepen understanding of the technical solutions of the present application, the present application further provides a scenario embodiment under specific application scenario for illustration.

The general-purpose registers provided in the present application may be logically divided into common registers and control registers according to difference in functions. The common registers are registers for configuring computing parameters, and the control registers are registers for controlling the execution of instructions.

In the present invention, related allocation management strategies are designed for the common register and control register respectively.

Common registers are mainly configured to store computing parameters, and the instructions are released after they are dispatched and executed, so the life cycle is short. Therefore, the main problem that needs to be solved in the allocation management of common registers is register conflict. Register conflict refers to the fact that when the same general-purpose register is assigned to multiple instructions that are executed at the same time, the register is to be read and written by multiple instructions at the same time, which in turn affects the correctness of the instruction results.

To solve this problem, in the present application, a global register state memory and a global register allocation recorder are designed. The state memory is a global Boolean list data structure for storing the usage state of general-purpose registers, which is True when in use and False when not in use; during initialization, all the values are False, and once a register is assigned, the corresponding position of the state memory is True. The allocation recorder is a global variable-length list data structure for storing the allocated register numbers. Once a register is allocated, the serial number of the register is added to the allocation recorder.

Since the life cycle of a common register needs to be maintained only until the current instruction is dispatched for execution, the common register allocated by the current instruction needs to be released before the next instruction processes register allocation. The specific method of releasing the common registers is to traverse the common register allocation recorder, set the corresponding position of the global state memory corresponding to all the recorded allocated registers to a False (unused) state, and then clear the allocation recorder.

When common registers are allocated, it is necessary to determine whether there are enough unused common registers, and the number of common registers required for each instruction is different and should be determined according to the instruction set. The specific method of allocating registers is to traverse the register state memory from smallest to largest of subscripts, find the common register with the state being False (unused), record the serial number of the common register, and set the position of the state register to True (allocated) until the required number of common registers are obtained.

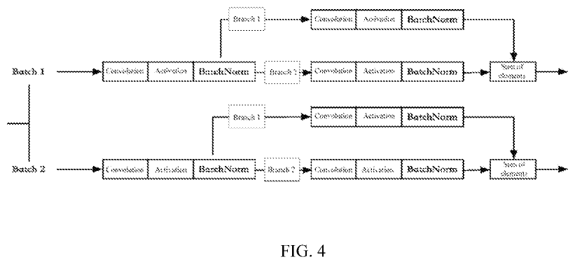

The main difficulty in managing the allocation of control registers is to determine the computing dependency relationship between different instructions based on the convolutional network computation graph. No dependency between two instructions means that the order of instruction execution does not affect the correctness of the result. As shown in FIG. 4 which is a schematic diagram of the convolutional network computation under the scenario embodiment of the present application, batch 1 and batch 2 refer to two batches of data to be processed, and the two batches of data will go through the same computing process; branch 1 and branch 2 are two branches in the neural network structure.

It may be seen from FIG. 4 that, the instructions within a batch tend to be dependent, for example, the input of an activation instruction is the output of a convolution instruction, therefore, the activation instruction may be executed after waiting for the completion of the convolution instruction; while the batches tend to be independent of each other. The relationship can be described as follows: the same batch waits and different batches do not wait. The dependency relationship between branches is more complicated, and the features may be summarized as that the smallest child node needs to wait for the largest parent node, and the remaining nodes have no dependency.

In order to achieve automatic analysis of the above dependency relationship, in the present invention, a child node recorder and a setting register recorder are designed, to record the key information required for dependency analysis. The child node recorder is a global key-value pair (dictionary) type data structure to record the child nodes of each node. The setting register recorder is also a global key-value pair (dictionary) type data structure, to record the allocation history of the setting register of each node.

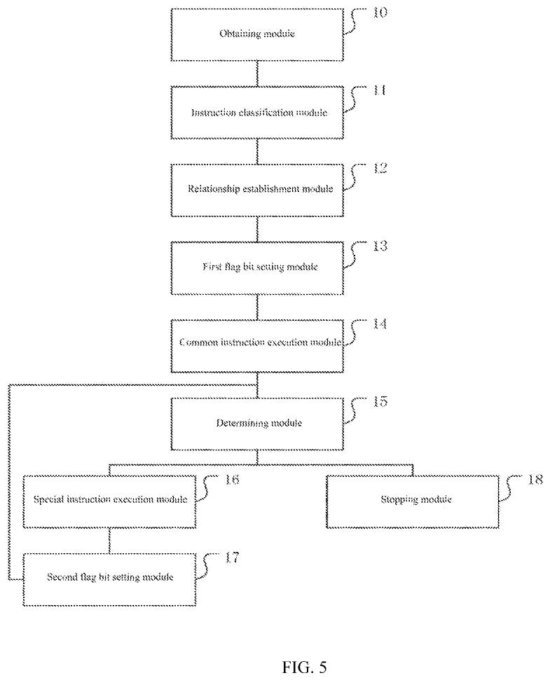

Please refer to FIG. 5, embodiments of the present application disclose an instruction execution apparatus, including:

an obtaining module 10, configured to obtain an instruction stream, and obtain an execution relationship between instructions, the instruction stream including an instruction indicating that contents of a first flag bit and a second flag bit are empty;

an instruction classification module 11, configured to obtain, according to the execution relationship between instructions, special instructions with an execution dependency relationship and common instructions without the execution dependency relationship in the instruction stream;

a relationship establishment module 12, configured to establish a data access relationship of the second flag bit of a first special instruction and the first flag bit of a second special instruction in the special instructions to a same storage address, the first special instruction being executed adjacent to the second special instruction and executed before the second special instruction;

a first flag bit setting module 13, configured to set state information satisfying an executable standard to the first flag bit that executes a special instruction with the highest priority;

a common instruction execution module 14, configured to execute the common instructions;

a determining module 15, configured to determine whether there are unexecuted special instructions in the instruction stream or not, if so, call in turn a special instruction execution module 16 and a second flag bit setting module 17, otherwise, call a stopping module 18;

the special instruction execution module 16 is configured to obtain a target special instruction with the state information corresponding to the first flag bit satisfying the executable standard from the unexecuted special instructions, and execute the target special instruction;

the second flag bit setting module 17 is configured to, after the target special instruction is executed, set state information satisfying the executable standard for a second flag bit of the target special instruction, and call the determining module 15; and

the stopping module 18 is configured to stop executing the instruction stream.

As to the instruction execution apparatus provided in the present application, first an instruction stream is obtained, the instruction of the instruction stream contains a first flag bit and a second flag bit and the contents are both empty, and further special instructions with an execution dependency relationship and common instructions without the execution dependency relationship in the instruction stream are obtained according to the execution relationship between instructions, a data access relationship is established of a second flag bit of a first special instruction executed first and a first flag bit of a second special instruction executed later in the adjacent special instructions to the same storage address, the state information satisfying an executable standard is set to the first flag bit that executes a special instruction with the highest priority, and then a common instruction is executed, and when there are unexecuted special instructions in the instruction stream, the target special instruction with the state information corresponding to the first flag bit satisfying the executable standard is executed, and the state information satisfying an executable standard is set to the second flat bit of the target special instruction, until all the special instructions are executed. Since the instruction of the instruction stream contains the first flag bit and the second flag bit, when the instruction is executed, special instructions with an execution dependency relationship and common instructions without the execution dependency relationship are executed in a differentiated manner, between any two adjacently executed instructions with an execution dependency relationship, the second flag bit executing the instruction first and the first flag bit executing the instruction later share the same storage address, therefore, after the execution of the instruction which is executed first is finished, state information satisfying an executable standard is set to the second flag bit, and execution of the instruction executed later adjacent to the instruction executed first is further triggered, therefore, normal execution of the instructions without an execution dependency relationship in the batch processing process is ensured, and meanwhile, ordered execution of the instructions with the execution dependency relationship is ensured, and then the correctness of instruction execution results is ensured.

In addition, embodiments of the present application further disclose an instruction execution device, including:

a memory, configured to store computer programs; and

a processor, configured to implement, when executing the computer programs, the steps of the above instruction execution method.

As to the instruction execution device provided in the present application, first an instruction stream is obtained, the instruction of the instruction stream contains a first flag bit and a second flag bit and the contents are both empty, and further special instructions with an execution dependency relationship and common instructions without the execution dependency relationship in the instruction stream are obtained according to the execution relationship between instructions, a data access relationship is established of a second flag bit of a first special instruction executed first and a first flag bit of a second special instruction executed later in the adjacent special instructions to the same storage address, the state information satisfying an executable standard is set to the first flag bit that executes a special instruction with the highest priority, and then a common instruction is executed, and when there are unexecuted special instructions in the instruction stream, the target special instruction with the state information corresponding to the first flag bit satisfying the executable standard is executed, and the state information satisfying an executable standard is set to the second flat bit of the target special instruction, until all the special instructions are executed. Since the instruction of the instruction stream contains the first flag bit and the second flag bit, when the instruction is executed, special instructions with an execution dependency relationship and common instructions without the execution dependency relationship are executed in a differentiated manner, between any two adjacently executed instructions with an execution dependency relationship, the second flag bit executing the instruction first and the first flag bit executing the instruction later share the same storage address, therefore, after the execution of the instruction which is executed first is finished, state information satisfying an executable standard is set to the second flag bit, and execution of the instruction executed later adjacent to the instruction executed first is further triggered, therefore, normal execution of the instructions without an execution dependency relationship in the batch processing process is ensured, and meanwhile, ordered execution of the instructions with the execution dependency relationship is ensured, and then the correctness of instruction execution results is ensured.

In addition, embodiments of the present application further disclose a computer-readable storage medium, the computer-readable storage medium stores a computer program, and the computer program, when being executed by the processor, implements the steps of the above instruction execution method.

As to the computer-readable storage medium provided in the present application, first an instruction stream is obtained, the instruction of the instruction stream contains a first flag bit and a second flag bit and the contents are both empty, and further special instructions with an execution dependency relationship and common instructions without the execution dependency relationship in the instruction stream are obtained according to the execution relationship between instructions, a data access relationship is established of a second flag bit of a first special instruction executed first and a first flag bit of a second special instruction executed later in the adjacent special instructions to the same storage address, the state information satisfying an executable standard is set to the first flag bit that executes a special instruction with the highest priority, and then a common instruction is executed, and when there are unexecuted special instructions in the instruction stream, the target special instruction with the state information corresponding to the first flag bit satisfying the executable standard is executed, and the state information satisfying an executable standard is set to the second flat bit of the target special instruction, until all the special instructions are executed. Since the instruction of the instruction stream contains the first flag bit and the second flag bit, when the instruction is executed, special instructions with an execution dependency relationship and common instructions without the execution dependency relationship are executed in a differentiated manner, between any two adjacently executed instructions with an execution dependency relationship, the second flag bit executing the instruction first and the first flag bit executing the instruction later share the same storage address, therefore, after the execution of the instruction which is executed first is finished, the state information satisfying an executable standard is set to the second flag bit, and execution of the instruction executed later adjacent to the instruction executed first is further triggered, therefore, normal execution of the instructions without an execution dependency relationship in the batch processing process is ensured, and meanwhile, ordered execution of the instructions with the execution dependency relationship is ensured, and then the correctness of instruction execution results is ensured.

An instruction execution method, apparatus and device and a storage medium provided in the present application are introduced in detail above. Each embodiment in the specification is described in a progressive manner, and each embodiment focuses on the differences from other embodiments, and the same or similar parts between each embodiment can be referenced with each other. For the apparatus disclosed in the embodiment, since it corresponds to the method disclosed in the embodiment, so the description is relatively simple, and for the relevant parts, please refer to the description in the method section. It should be noted that for those skilled in the art, numerous improvements and modifications may be made to the present application without departing from the principles of the present application, and these improvements and modifications also all fall within the protection scope of the claims of the present application.

It should also be noted that in the present specification, relationship terms such as first and second are merely used to distinguish one entity or operation from another entity or operation, and do not necessarily require or imply any such actual relationship or order between those entities or operations. Further, the terms “includes”, “comprises” or any other variation thereof are intended to cover non-exclusive inclusion, such that a process, method, article, or device including a series of elements includes not only those elements, but also other elements not expressly listed, or elements that are inherent to such a process, method, article, or device. Without further limitation, the elements defined by the statement “including a ” do not preclude the existence of additional identical elements in the process, method, article, or device that include the elements.

1. An instruction execution method, comprising:
obtaining an instruction stream, and obtaining an execution relationship between instructions, the instruction stream comprising an instruction indicating that contents of a first flag bit and a second flag bit are empty;
obtaining, according to the execution relationship between instructions, special instructions with an execution dependency relationship and common instructions without the execution dependency relationship in the instruction stream;
establishing a data access relationship of the second flag bit of a first special instruction and the first flag bit of a second special instruction in the special instructions to a same storage address, the first special instruction being executed adjacent to the second special instruction and executed before the second special instruction;
setting state information satisfying an executable standard to the first flag bit that executes a special instruction with the highest priority;
executing the common instructions;
determining whether there are unexecuted special instructions in the instruction stream or not;
obtaining a target special instruction with the state information corresponding to the first flag bit satisfying the executable standard from the unexecuted special instructions if there are unexecuted special instructions in the instruction stream, and executing the target special instruction;
after the target special instruction is executed, setting state information satisfying the executable standard for a second flag bit of the target special instruction, and performing the step of determining whether there are unexecuted special instructions in the instruction stream or not; and
stopping executing the instruction stream if there are no unexecuted special instructions in the instruction stream.

2. The instruction execution method of claim 1, wherein establishing a data access relationship of the second flag bit of a first special instruction and the first flag bit of a second special instruction in the special instructions to a same storage address comprises:
obtaining a control register allocation table and obtaining a target control register in an unallocated state according to the control register allocation table; and
establishing the data access relationship of the second flag bit of the first special instruction and the first flag bit of the second special instruction in the special instructions to the same register storage address of the target control register.

3. The instruction execution method of claim 2, further comprising:
obtaining a common register allocation table and obtaining a target common register in an unallocated state according to the common register allocation table; and
storing instruction parameters in the instruction other than the first flag bit and the second flag bit by using the target common register.

4. The instruction execution method of claim 2, wherein after executing the common instruction, the method further comprises:
releasing the common register corresponding to the common instruction, and setting the allocation state of the common register corresponding to the common instruction in the common register allocation table to an unallocated state;
the method further comprises:
releasing the common register corresponding to the target special instruction, and setting the allocation state of the common register corresponding to the target special instruction in the common register allocation table to an unallocated state; and
releasing the control register corresponding to the target special instruction, and setting the allocation state of the control register corresponding to the target special instruction in the control register allocation table to an unallocated state.

5. The instruction execution method of claim 3, wherein the common register allocation table and the control register allocation table are both dictionary-type data structures.

6. The instruction execution method of claim 2, wherein setting state information satisfying an executable standard to the first flag bit that executes a special instruction with the highest priority comprises:
setting a standard value for the control register corresponding to the first flag bit that executes the special instruction with the highest priority;
the obtaining a target special instruction with the state information corresponding to the first flag bit satisfying the executable standard from the unexecuted special instructions comprises:
reading the unexecuted special instruction, and obtaining the state value stored in the corresponding control register according to the first flag bit of the unexecuted special instruction;
determining whether the state value is equal to the standard value;
if the state value is equal to the standard value, setting the unexecuted special instruction to the target special instruction;
the setting state information satisfying the executable standard for a second flag bit of the target special instruction after the target special instruction is executed comprises:
after the target special instruction is executed, setting the standard value for the control register corresponding to the second flag bit of the target special instruction.

7. The instruction execution method of claim 6, wherein the standard values take values including 0 or 1.

8. (canceled)

9. An instruction execution device, comprising:
a memory, configured to store computer programs; and
a processor, configured to implement, when executing the computer programs, the steps of the instruction execution method, comprising:
obtaining an instruction stream, and obtaining an execution relationship between instructions, the instruction stream comprising an instruction indicating that contents of a first flag bit and a second flag bit are empty;
obtaining, according to the execution relationship between instructions, special instructions with an execution dependency relationship and common instructions without the execution dependency relationship in the instruction stream:
establishing a data access relationship of the second flag bit of a first special instruction and the first flag bit of a second special instruction in the special instructions to a same storage address, the first special instruction being executed adjacent to the second special instruction and executed before the second special instruction;
setting state information satisfying an executable standard to the first flag bit that executes a special instruction with the highest priority;
executing the common instructions;
determining whether there are unexecuted special instructions in the instruction stream or not;
obtaining a target special instruction with the state information corresponding to the first flag bit satisfying the executable standard from the unexecuted special instructions if there are unexecuted special instructions in the instruction stream, and executing the target special instruction;
after the target special instruction is executed, setting state information satisfying the executable standard for a second flag bit of the target special instruction, and performing the step of determining whether there are unexecuted special instructions in the instruction stream or not; and
stopping executing the instruction stream if there are no unexecuted special instructions in the instruction stream.

10. A computer-readable storage medium, wherein the computer-readable storage medium stores a computer program, and the computer program, when being executed by the processor, implements the following steps:
obtaining an instruction stream, and obtaining an execution relationship between instructions, the instruction stream comprising an instruction indicating that contents of a first flag bit and a second flag bit are empty;
obtaining, according to the execution relationship between instructions, special instructions with an execution dependency relationship and common instructions without the execution dependency relationship in the instruction stream;
establishing a data access relationship of the second flag bit of a first special instruction and the first flag bit of a second special instruction in the special instructions to a same storage address, the first special instruction being executed adjacent to the second special instruction and executed before the second special instruction;
setting state information satisfying an executable standard to the first flag bit that executes a special instruction with the highest priority;
executing the common instructions;
determining whether there are unexecuted special instructions in the instruction stream or not;
obtaining a target special instruction with the state information corresponding to the first flag bit satisfying the executable standard from the unexecuted special instructions if there are unexecuted special instructions in the instruction stream, and executing the target special instruction;
after the target special instruction is executed, setting state information satisfying the executable standard for a second flag bit of the target special instruction, and performing the step of determining whether there are unexecuted special instructions in the instruction stream or not; and
stopping executing the instruction stream if there are no unexecuted special instructions in the instruction stream.

11. The instruction execution method of claim 3, wherein setting state information satisfying an executable standard to the first flag bit that executes a special instruction with the highest priority comprises:
setting a standard value for the control register corresponding to the first flag bit that executes the special instruction with the highest priority;
the obtaining a target special instruction with the state information corresponding to the first flag bit satisfying the executable standard from the unexecuted special instructions comprises:
reading the unexecuted special instruction, and obtaining the state value stored in the corresponding control register according to the first flag bit of the unexecuted special instruction;
determining whether the state value is equal to the standard value;
if the state value is equal to the standard value, setting the unexecuted special instruction to the target special instruction;
the setting state information satisfying the executable standard for a second flag bit of the target special instruction after the target special instruction is executed comprises:
after the target special instruction is executed, setting the standard value for the control register corresponding to the second flag bit of the target special instruction.

12. The instruction execution method of claim 4, wherein setting state information satisfying an executable standard to the first flag bit that executes a special instruction with the highest priority comprises:
setting a standard value for the control register corresponding to the first flag bit that executes the special instruction with the highest priority;
the obtaining a target special instruction with the state information corresponding to the first flag bit satisfying the executable standard from the unexecuted special instructions comprises:
reading the unexecuted special instruction, and obtaining the state value stored in the corresponding control register according to the first flag bit of the unexecuted special instruction;
determining whether the state value is equal to the standard value;
if the state value is equal to the standard value, setting the unexecuted special instruction to the target special instruction;
the setting state information satisfying the executable standard for a second flag bit of the target special instruction after the target special instruction is executed comprises:
after the target special instruction is executed, setting the standard value for the control register corresponding to the second flag bit of the target special instruction.

13. The instruction execution method of claim 5, wherein setting state information satisfying an executable standard to the first flag bit that executes a special instruction with the highest priority comprises:
setting a standard value for the control register corresponding to the first flag bit that executes the special instruction with the highest priority;
the obtaining a target special instruction with the state information corresponding to the first flag bit satisfying the executable standard from the unexecuted special instructions comprises:
reading the unexecuted special instruction, and obtaining the state value stored in the corresponding control register according to the first flag bit of the unexecuted special instruction;
determining whether the state value is equal to the standard value;
if the state value is equal to the standard value, setting the unexecuted special instruction to the target special instruction;
the setting state information satisfying the executable standard for a second flag bit of the target special instruction after the target special instruction is executed comprises:
after the target special instruction is executed, setting the standard value for the control register corresponding to the second flag bit of the target special instruction.

14. The instruction execution method of claim 7, wherein the standard values take values including 0 or 1.

15. The instruction execution method of claim 8, wherein the standard values take values including 0 or 1.

16. The instruction execution method of claim 9, wherein the standard values take values including 0 or 1.

17. The instruction execution device of claim 9, wherein establishing a data access relationship of the second flag bit of a first special instruction and the first flag bit of a second special instruction in the special instructions to a same storage address comprises:
obtaining a control register allocation table and obtaining a target control register in an unallocated state according to the control register allocation table; and
establishing the data access relationship of the second flag bit of the first special instruction and the first flag bit of the second special instruction in the special instructions to the same register storage address of the target control register.

18. The instruction execution device of claim 17, further comprising:
obtaining a common register allocation table and obtaining a target common register in an unallocated state according to the common register allocation table; and
storing instruction parameters in the instruction other than the first flag bit and the second flag bit by using the target common register.

19. The instruction execution device of claim 18, wherein the common register allocation table and the control register allocation table are both dictionary-type data structures.

20. The instruction execution device of claim 17, wherein after executing the common instruction, the method further comprises:
releasing the common register corresponding to the common instruction, and setting the allocation state of the common register corresponding to the common instruction in the common register allocation table to an unallocated state;
the method further comprises:
releasing the common register corresponding to the target special instruction, and setting the allocation state of the common register corresponding to the target special instruction in the common register allocation table to an unallocated state; and
releasing the control register corresponding to the target special instruction, and setting the allocation state of the control register corresponding to the target special instruction in the control register allocation table to an unallocated state.

21. The instruction execution device of claim 17, wherein setting state information satisfying an executable standard to the first flag bit that executes a special instruction with the highest priority comprises:
setting a standard value for the control register corresponding to the first flag bit that executes the special instruction with the highest priority;
the obtaining a target special instruction with the state information corresponding to the first flag bit satisfying the executable standard from the unexecuted special instructions comprises:
reading the unexecuted special instruction, and obtaining the state value stored in the corresponding control register according to the first flag bit of the unexecuted special instruction;
determining whether the state value is equal to the standard value;
if the state value is equal to the standard value, setting the unexecuted special instruction to the target special instruction;
the setting state information satisfying the executable standard for a second flag bit of the target special instruction after the target special instruction is executed comprises:
after the target special instruction is executed, setting the standard value for the control register corresponding to the second flag bit of the target special instruction.
